(19) United States
(12) Patent Application Publication
(10) Pub. No.: US 2012/0315948 A1
(43) Pub. Date: Dec. 13, 2012

(54) Method and Apparatus for Controlling Energy Consumption in a Multi-Antenna Base Station

(75) Inventors: Pål Frenger, Linkoping (SE); George Jöngren, Sundbyberg (SE); Stefan Parkvall, Stockholm (SE)

(73) Assignee: Telefonaktiebolaget LM Ericsson (publ), Stockholm (SE)

(21) Appl. No.: 13/580,062

(22) PCT Filed: Feb. 24, 2010
(86) PCT No.: PCT/SE2010/050211

§ 371 Date: Aug. 20, 2012

(51) Int. Cl. H04W 52/02; H04W 52/04

(52) U.S. Cl. 455/522

(57) ABSTRACT

The present invention relates generally to a method for use in a radio base station of a wireless communications network and to an energy control apparatus (210), more particularly to a method for reducing energy consumption in a multi-antenna multi-port radio base station (220) of a multi-input multi-output wireless communications network. The radio base station (220) is serving a cell (230) and comprising at least two antenna ports (240a; 240b; 240c; 240d) dedicated for that cell (230). The method comprises measuring a load in the cell (230) and comparing the measured load with a defined load value. The method also comprises muting a downlink transmission power transmitted on at least one of the at least two antenna ports (240a; 240b; 240c; 240d) when the measured load is below the defined load value, and thereby reducing energy consumption.

### TECHNICAL FIELD

The present invention relates generally to a method for use in a radio base station of a wireless communications network and to an apparatus for controlling energy, more particularly to a method for reducing energy consumption in a multi-antenna multi-port radio base station of a multi-input multi-output (MIMO) wireless communications network.

### BACKGROUND

Over the last few years, power consumption, i.e. energy efficiency, has become more and more important. Undoubtedly, communication technology may contribute significantly in decreasing the CO₂ emissions, e.g., by avoiding traveling. At the same time there is a general requirement to decrease the energy consumption of telecommunication equipments. This is not only essential from a societal perspective in order to contribute to a sustainable world, but also for being able to offer attractive and competitive products and to cut down costs.

The costs of running a wireless communications network are reaching a same level comparable to personnel costs it is therefore obvious that energy consumption costs are also becoming a heavy burden. While operation expenditures (OPEX) reductions have been in focus for quite a while, attention to increased energy consumption has not been as relevant during those years. Now, there is a great interest in decreasing energy consumption and thereby decreasing the cost of running a wireless communications network.

When scrutinizing power consumers in a wireless communications network, it turns out that in such a network, radio base stations are the main power consumers. Traditionally, User Equipments (UEs), e.g. mobile terminals, laptops, PDAs, etc. have been designed having power consumption/efficiency in mind due to their battery limitations. In addition, Core Networks (CNs) are in absolute terms only marginal consumers of power, because compared to a number of radio base stations there are only a few CN nodes.

One example of such a wireless communications network is a Long Term Evolution (LTE) network, which is considered as a step in a development of Universal Mobile Telecommunications System (UMTS) beyond the original 3rd generation Wideband Code Division Multiple Access (WCDMA) radio access technology. LTE comprises a new radio interface and new radio access network architecture. LTE is also known as the Evolved Universal Terrestrial Radio Access (E-UTRA) standard, as promulgated by the Third Generation Partnership Project (3GPP). The term LTE will be used throughout most of the application but the general embodiments are not limited to this particular standard.

According to one of the E-UTRA standard technical specifications 3GPP TS 36.211, entitled: “3^{rd} generation Partnership Project; Technical Specification Group Radio Access Network; Evolved Universal Terrestrial Radio Access (E-UTRA); Physical Channels and Modulation”, in case of multi-antenna transmission in downlink one or more antenna ports are to be used, wherein each antenna port is further connected to one or more antennas in the radio base station. Each antenna port is defined by an associated Reference Signal (RS), which is a signal known to a receiver and which is inserted into a transmitted signal, between a radio base station and UEs, in order to facilitate channel estimation for coherent demodulation and measurements. In LTE downlink, Cell-specific RSs are provided which are available to all UEs in a cell; UE-specific RSs may be embedded in the data for specific UEs, and Multimedia Broadcast Single Frequency Network (MBSFN) specific RSs are provided in case of MBSFN operation. These RSs occupy specified Resource Elements (REs) within an Orthogonal Frequency Division Multiplexed (OFDM) symbol.

The above mentioned technical specification does not state anything about an actual number of antennas used by an LTE radio base station, also denoted eNB, eNodeB, evolved NodeB, in relation to a number of antenna ports. Each eNodeB may serve one or more Evolved Universal Terrestrial Radio Access Network (E-UTRAN) cells.

Thus, a single antenna port may be implemented using multiple physical antenna elements, although seen from a UE perspective, this is still a single antenna port as there is only one reference signal for all the physical antennas using the same antenna port. An antenna port may therefore be considered to correspond to a transmit antenna as seen from the UE side. Transmissions from multiple antenna ports to a single UE is in LTE, and according to the technical specification mentioned above, based on Cell-Specific Reference Signals (CS-RS).

As shown in FIG. 1, a radio base station (RBS) 120 of a prior art wireless communications network 100 is depicted having several antenna ports 140a; 140b; 140c; 140d, and for each one of the up to four cell-specific antenna ports 140a; 140b; 140c; 140d, there is a cell-specific reference signal transmitted. FIG. 1 also depicts four exemplary cells 130.

Layer1/Layer2 (L1/L2) control signaling in LTE, as specified in Release 8, always uses cell-specific antenna ports i.e. for a Physical Downlink Control CHannel (PDCCH); a Physical Control Format Indicator CHannel (PCFICH), or a Physical Hybrid ARQ Indicator CHannel (PHICH). In order to demodulate the L1/L2 control signaling, the UE, in a cell, needs to obtain information about the number of cell-specific antenna ports in the cell. This information may be obtained by, blindly, decoding a so called Physical Broadcast CHannel (PBCH). The PBCH is usually transmitted on a same set of antenna ports (({O}, {0, 1}, or {0, 1, 2, 3}) as denoted cell-specific reference signals in the earlier mentioned technical specification. Different Cyclic Redundancy Check (CRC) masks may be used for data transmitted in data blocks on the PBCH and depend on the number of cell-specific antenna ports. The CRC masks are error detecting codes appended to data blocks to be transmitted. Thus, in practice, the UEs determine the number of cell-specific antenna ports by a CRC check and, as long as the PBCH can be received, the UEs may correctly identify the number of cell-specific antenna ports.

As described above, the number of cell-specific antenna ports may be determined from the CRC check on the data received on the PBCH. In conventional LTE networks the number of cell-specific antenna ports is determined to be static. The UE is therefore required to determine the number of cell-specific antenna ports upon initial connection to the cell. The UE is not required to re-evaluate the number of cell-specific antenna ports it is connected to once it has connected to the cell.

A disadvantage with the above mentioned approach is that if the radio base station has e.g. dedicated four cell-specific antenna ports for use in a cell, all the L1/L2 control signaling needs to use the four antenna ports. Also, it is required that cell-specific reference signals are to be transmitted, from the radio base station, on all cell-specific antenna ports all the time, since they are to be used by the UEs when performing coherent demodulation. This approach is power consuming and therefore not as cost effective and is not environment friendly as it could be.

### SUMMARY

An object of exemplary embodiments of the present invention is thus to provide a energy control apparatus and a method for reducing energy consumption in a MIMO wireless communications network thereby reducing the costs of running the network i.e. by muting downlink transmission on at least one antenna port when a measured load in a cell is determined to be low.

According to an aspect of exemplary embodiments of the present invention, at least some the previously stated problems are solved by means of an apparatus for use in a multi-antenna multi-port radio base station of a MIMO wireless communications network, for controlling energy. The radio base station is configured to serve a cell and comprises at least two antenna ports that are dedicated for that cell. The apparatus comprises a measurement circuit which is adapted to measure a load in the cell and a comparator circuit adapted to compare the measured load value with a defined load value. The apparatus further comprises a power control circuit adapted to mute a downlink transmission power transmitted on at least one of the at least two antenna ports when the measured value is below the defined load value.

According to another aspect of exemplary embodiments of the present invention, at least some the previously stated problems are solved by means of a method for controlling energy consumption and for use in a multi-antenna multi-port radio base station of a multi-input multi-output wireless communications network. The radio base station is serving a cell and comprising at least two antenna ports dedicated for that cell. The method comprises measuring a load in the cell and comparing the measured load with a defined load value. The method further comprises muting a downlink transmission power transmitted on at least one of the at least two antenna ports when the measured load is below the defined load value.

An advantage of the exemplary embodiments of the present invention is that energy/power consumption is reduced due to that one or more transmission antenna ports of a multi-antenna multi-port radio base station are muted e.g. one or more power amplifier are inactivated or muted resulting in saved energy.

Another advantage of the exemplary embodiments of the present invention is that the overall costs for running e.g. a MIMO wireless communications network are reduced.

Another advantage of the exemplary embodiments of the present invention is that the apparatus achieves better downlink power control and more efficient downlink power management in e.g. a MIMO wireless communications network.

Still other advantages, objects and features of the embodiments of the present invention will become apparent from the following detailed description in conjunction with the accompanying drawings, attention to be called to the fact, however, that the following drawings are illustrative only, and that various modifications and changes may be made in the specific embodiments illustrated as described within the scope of the appended claims.

### BRIEF DESCRIPTION OF THE DRAWINGS

FIG. 1 is a block diagram illustrating a prior art wireless communications network wherein a radio base stations is equipped with four cell-specific antenna ports.

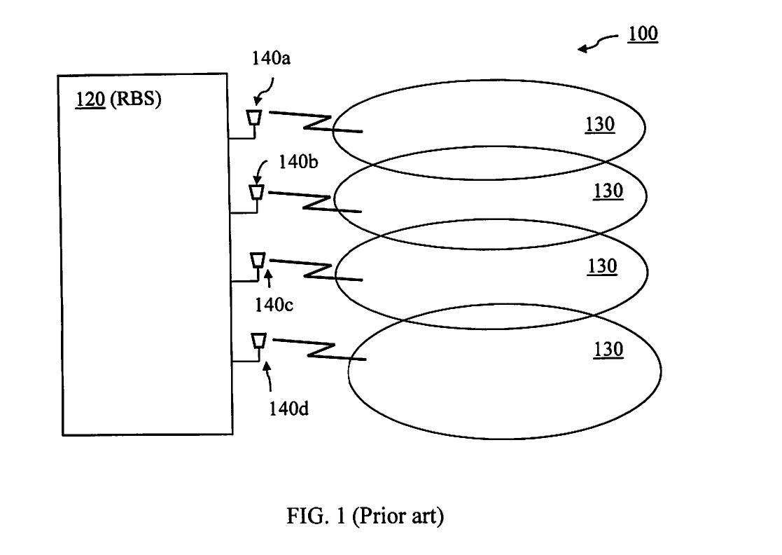

FIG. 2 is a block diagram illustrating a wireless communications network wherein a radio base station have several controllable antenna ports, according to an exemplary embodiment of the present invention.

FIG. 3 is another block diagram illustrating a wireless communications network wherein a radio base station is equipped with several controllable antenna ports in accordance with an exemplary embodiment of the present invention.

FIGS. 4A-4B are examples illustrating muting of antenna ports in accordance with an exemplary embodiment of the present invention.

FIG. 5 is a flowchart of a method for controlling energy consumption according to an exemplary embodiment of the present invention.

FIG. 6 is a flowchart of a method for controlling energy consumption according to a further exemplary embodiment of the present invention.

### DETAILED DESCRIPTION

In the following description, for purposes of explanation and not limitation, specific details are set forth such as particular architectures, scenarios, techniques, etc. in order to provide thorough understanding of the present invention. However, it will be apparent from the following that the present invention and its embodiments may be practiced in other embodiments that depart from these specific details. The exemplary embodiments of the present invention are described herein by way of reference to particular example scenarios. In particular the invention is described in a non-limiting general context in relation to a LTE network. Note that the present invention is applicable to any wireless communications network having a multi-antenna multi-port radio base station, such as in WCDMA. Note also that the exemplary embodiments of the present invention are not either restricted to a MIMO system.

Following will be described exemplary embodiments of the present invention disclosing energy control apparatus and method for reducing energy consumption in a multiple-input multiple-output (MIMO) wireless communications network. Reducing energy consumption is achieved by muting, or e.g. inactivating, downlink transmission on at least one antenna port when a measured load in a cell is determined to be low. Advantages of reducing energy consumption are e.g. that the costs of running a network is reduced and the bad influence on the environment caused by a wireless communications network consuming power is also reduces.

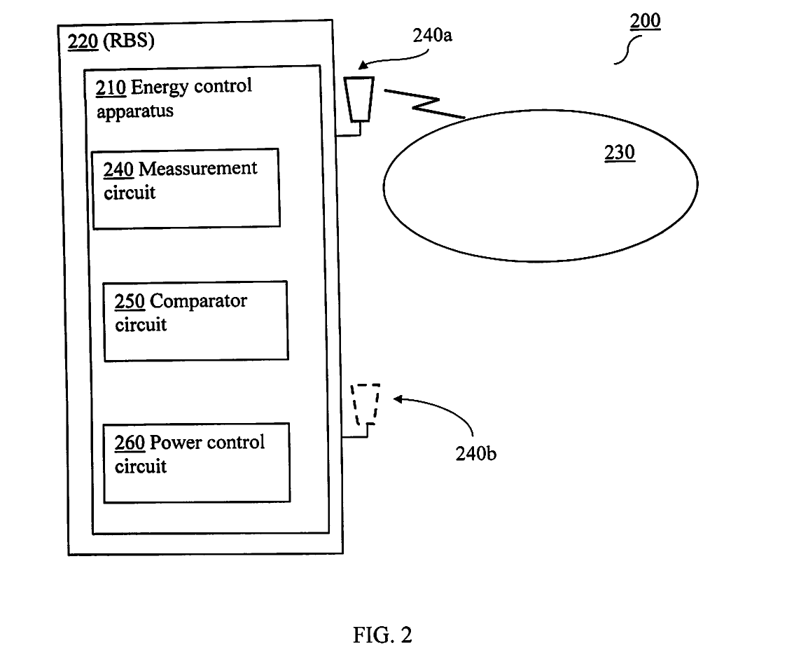

FIG. 2 illustrates an exemplary radio base station 220, of a wireless communications network 200, comprising several controllable antenna ports, according to an exemplary embodiment of the present invention. According to this embodiment the radio base station 220, serving a cell 230, is a multi-antenna multi-port radio base station comprising two antenna ports 240a, 240b that are dedicated for that cell 230. As shown, the radio base station 220 also comprises an energy control apparatus 210 which, according to the exemplary embodiments of the present invention, comprises: a measurement circuit 240, a comparator circuit 250 and a power control circuit 260. The measurement circuit 240 is adapted to measure a load in the cell 230. The comparator circuit 250 is adapted to compare the measured load with a defined value, and based on the result of the comparison, the power control circuit 260 is adapted to mute a downlink transmission power transmitted on one of the two antenna ports 240a, 240b when the measured load is below the defined load value. In FIG. 2, antenna port 240b is considered muted and this is indicated by dashed lines depicting antenna port 240b. This way, energy consumption is reduced i.e. power saving is achieved when the load in the cell is determined to be lower that the defined value. According to exemplary embodiments of the present invention the measured load in the cell is one or more of the following: cell traffic load; data rate; number of served user equipments (UEs) in the cell; number of scheduled resource elements; Signal to Interference-plus-Noise Ratio (SINR) margin on downlink common channels; time period statistics; type of UEs in the cell; and packet delay estimations. Time period statistics are e.g. based on statistics collected revealing that certain hours during the day/night the load in the cell is low. The type of UEs in the cell may reveal that there are no UEs in the network that support e.g. MIMO or multi-stream transmission, and therefore there are no benefits in using multiple ports. Depending on the type of load to be measure, one or more thresholds can thus be used to determine if the load in a cell is low, or high. For instance, if the load to measure is the number of active UEs in the cell, a threshold can define a maximum number of UEs to be active at the same time. If the load to measure is the interference or the SINR margin on downlink channels, a threshold can define a lowest perceived SINR margin. The threshold(s) can therefore be viewed as designed parameters determined through experimentations. The exemplary embodiments of the present invention are not restricted to any particular measurable load i.e. the list of exemplary loads indicated above is not exhaustive. Note however, that that both the average load and the instantaneous load can be taken into consideration. As an example even if the measured average load is below the defined value or the threshold one can choose not to mute because in this time instant some data can maybe transmitted. Thus, a measured load can be a function taking into consideration both the average and/or the simultaneous load.

It should be mentioned that each antenna port of the RBS 220 is connected to one or more power amplifiers (PAs) and to one or more antennas elements. This is however not explicitly shown in the figures. For easily understanding the exemplary embodiments of the present invention, it is assumed the case where an antenna port is connected to one power amplifier (PA) and further connected to one antenna element. Thus, in this case and in conjunction with FIG. 2, as the comparator determines that the measured load is less than the defined value, the PA of antenna port 240b is muted thereby saving power and/or energy.

FIG. 2 illustrates only two antenna ports of the radio base station 220. However, the exemplary embodiments of the present invention present invention are also applicable for a radio base station comprising additional antenna ports e.g. 4, 6, 8 etc. and wherein each antenna port is equipped with or is connected to one or more related antenna elements and one or more PAs.

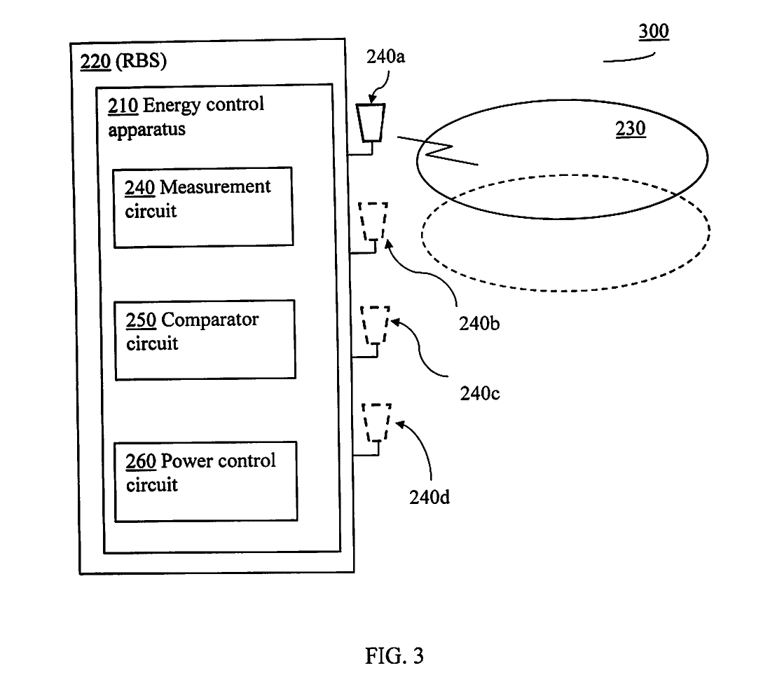

FIG. 3 illustrates an exemplary wireless communications network 300 wherein a multi-antenna multi-port radio base station 220 is shown comprising four controllable antenna ports denoted 240a; 240b; 240c; 240d, according to an exemplary embodiment of the present invention. A cell is denoted 230. The four antenna ports 240a; 240b; 240c; 240d are dedicated for that cell. The radio base station 220 is shown comprising, in accordance with the exemplary embodiments of the present invention, an energy control apparatus 210 which itself comprises: a measurement circuit 240, a comparator circuit 250 and a power control circuit 260. Similarly to the embodiments described in conjunction with FIG. 2, the measurement circuit 240 is adapted to measure a load in the cell 330. The comparator circuit 250 is adapted to compare the measured load with a defined value, and the power control circuit 260 is adapted to mute a downlink transmission power transmitted on one or more antenna ports e.g. 240b, 240c and 240d of the four antenna ports 240a; 240b; 240c; 240d when the measured load is below the defined load value. The PAs of antenna ports 240b, 240c and 240d are here considered muted or inactivated, as indicated in dashed lines, thereby saving power and/or energy.

Similarly to the previously described embodiments, the measured load in the cell can be one or more of the following: cell traffic load; data rate; number of served UEs in the cell; number of scheduled resource elements; SINR margin on downlink common channels; time period statistics; type of UEs in the cell; and packet delay estimations. Time period statistics are e.g. based on statistics collected revealing that certain hours during the day/night the load in the cell is low. The type of UEs in the cell may reveal that there are no UEs in the network that support e.g. MIMO or multi-stream transmission, and therefore there are no benefits in using multiple ports.

According to a further exemplary embodiment of the present invention the power control circuit 260 is further adapted to compensate for a loss of downlink transmission power. The compensation is achieved by increasing the downlink transmission power on one or several remaining antenna ports or on one or more PAs of the antenna ports that have not been muted. As an exemplary embodiment of the present invention, the power control circuit 260 may, due to the muting, compensate, for a loss of transmission of one or more of the following: downlink common channels (PBCH, PDCCH); pilot signals; downlink-cell specific reference signals; primary synchronization signals (PSS); and secondary signaling signals (SSS).

In the following, an example is presented to easily understand the above. In this example the radio base station is assumed comprising only two antenna ports, as in FIG. 2. One of the antenna ports is muted due to that the measured load is determined to be lower that a defined threshold load value. Again, by muting an antenna port is also meant inactivating one or more PM of the antenna port or decreasing to the maximum the one or more PAs of the antenna port.

It should be mentioned that when muting one of two antenna ports, the radio base station suffers from a downlink transmission power loss. Assume now that before the muting each antenna port or PA contributed with γ Watts downlink transmission power. The radio base station will have reduced its total downlink transmission power from 2γ Watts down to γ Watts. If the maximum output power of each antenna port or PA is at least 2γ Watts then the downlink transmission power loss on one antenna port or PA can be compensated for by an increase or by boosting on another antenna port or PA. In general it is almost always possible to increase the downlink transmission power, since wireless communication networks are often originally designed to be able to cope with high interference limited scenarios.

Thus, muting of an antenna port or PA leads to reduction in energy consumption when the measured load in the cell is determined to be low i.e. no load, or very little data traffic. This is also the case when the downlink transmission power spent on the common channels is just a small fraction of a total available downlink transmission power. Muting an antenna port or a Pa can be viewed as discontinuous transmission (DTX) since during the DTX period no PA is active i.e. the PA is turned off.

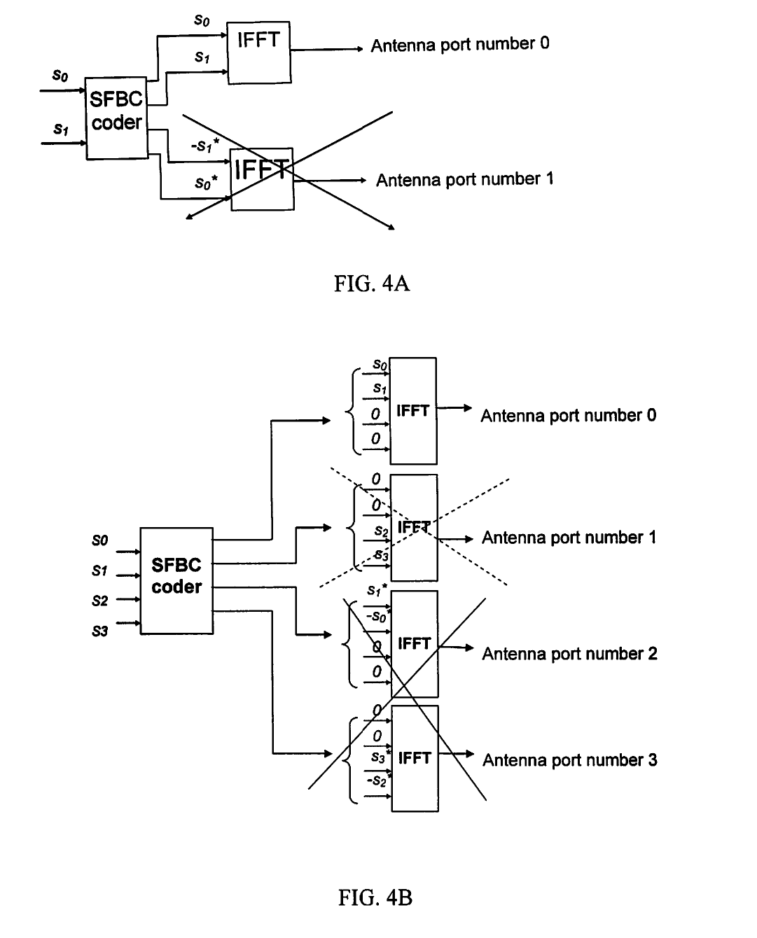

In LTE networks, the PBCH and the PDCCH are often over designed for robustness purposes so that it is possible to reach a cell edge even in largest cells and also when the inter-cell interference is high. Clearly, during non-peak hours the inter-cell interference level is often low and the additional transmit diversity gain provided by having two radio base station antenna ports active may not always be needed. Therefore, when muting one antenna port or PA(s) the transmission quality is considered to be minimally affected. FIG. 4A illustrates an exemplary scenario considering a radio base station comprising only two antenna ports as in FIG. 2. It is here considered that the radio base station is an LTE eNB capable in implementing the energy control apparatus according to the exemplary embodiments of the present invention. The coding used in LTE for PBCH and PDCCH is known as space frequency block code (SFBC). Thus in FIG. 4A, a 2 antenna ports SFBC coder, for an LTE eNB, is illustrated. S₀ and S₁ denote signals entering the SFBC coder which are then transmitted to inverse fast fourier transformers denoted IFFT. In this example it is assumed that S₀ and S₁ enters one IFFT and the conjugate of S₀ and S₁ denoted S₀* and −S₁* respectively enters the other IFFT. Antenna port number 1 connected to one IFFT is not muted, or not DTX:ed, whereas antenna port number 2 connected to the other IFFT is muter or DTX:ed. By muting antenna port number 1, one can effectively un-do the SFBC encoding. Since, as mentioned earlier, the PBCH and the PDCCH are often over designed for robustness so that it is possible to reach the cell edge even in the largest cells when the inter-cell interference is high. Thus transmit diversity gain provided by the two antenna ports is not always needed when transmitting e.g. robust channels as PBCH ad PDCCH. In addition, when the load is low the PAs can operate far below their maximum output power level and it is possible to boost the power on the remaining PA(s) in case some PA(s) are DTX:ed

Another example where the SFBC coder is also used in conjunction with 4 IFFT blocks in a LTE eNB having four transmit antenna ports numbered 0, 1, 2, and 4, are used, is shown in FIG. 4B. Four signals S₀, S₁, S₂, S₃ are shown entering the SFBC coder. The conjugate of signals are also shown. Each antenna port comprises or is connected to a respective PA. We can mute antenna ports 2 and 3, as indicated in FIG. 4B, and only suffer from a diversity loss and potentially also a power loss from using 2 PAs instead of 4 that can we compensate for by boosting the power of the remaining antennas, if needed. If we also mute antenna port 1, as indicated in FIG. 4B with dashed lines, then we are loosing half the channel code redundancy, and this will reduce the performance. Thus, when muting two out of antenna ports or PM the eNB will only suffer from a diversity loss, and potentially also experiencing downlink transmission power loss from using two PM instead of four PAs. Still it is possible, as mentioned earlier, for the power control circuit of the eNB, according to the previously described embodiment of the present invention, to compensate for the downlink transmission power loss by increasing or boosting the downlink transmission power of the remaining antenna ports, if needed. As mentioned above, if an additional antenna port or PA is also muted then half of the channel code redundancy of the radio base station is lost. For instance, assume that the channels under consideration, in conjunction with FIG. 4B, are the PBCH and the PDCCH. These channels are generally encoded with tail-biting convolutional codes with a parent code rate equal to 1/3 and a constraint having a length equal to seven. The effective code rate after rate matching can be approximately 0.013 for PBCH and in the approximate range of 0.1 to 0.7 for PDCCH. Note that the values 0.013, 0.1 and 0.7 are exemplary only i.e. the code rate values are implementation specific and/or design parameters.

By muting three of four antenna ports the radio base station is effectively left with a channel code having twice the effective code rate and this leads to a reduction in performance. For instance, muting of e.g. antenna port number 3 can be viewed as puncturing the channel code and puncturing is equivalent to throwing away every second coded bit. As a consequence the performance is reduced.

I mean if the code rate is well below 1/2 and we throw away every second coded bit (that is what the antenna muting does) then we still have a channel code with a code rate well below 1. That means that, even though the code strength is reduced by this puncturing, the code is still possible to decode.

However, if the initial code rate, i.e. the effective code rate before antenna port muting, is assured to be well below 1/2 then UEs would in many scenarios be able to decode the PBCH and the PDCCH even if for example 3 out of 4 antenna ports were muted. This could be the case e.g. for situations where there is low inter-cell interference, or when the SINR of common channels is sufficiently large. For instance if the code rate is well below 1/2 and we puncture or “throw away” every second coded bit as a result of the antenna muting, then one still have a channel code with a code rate well below 1. That means that, even though the code strength is reduced by this puncturing, the code is still possible to decode.

To partially compensate for the performance impact from the muted antenna port(s), the power control circuit, according to the exemplary embodiment of the present invention, is configured to the downlink transmission power on the remaining antenna port(s). For instance a single PA at high power is considered to be more efficient than multiple PAs running at a lower power. The PDCCH code rate can, by means of the (power/energy control) apparatus, be dynamically adjusted using a lower initial code rate of the PDCCH, in order to compensate for the performance impact mentioned above. Note that the values of the code rates are exemplary only i.e. the code rate values are implementation specific and/or design parameters.

As previously described, the apparatus, in accordance with the exemplary embodiments of the present invention, comprises a measurement circuit. This measurement circuit can be used to perform reference signal received power (RSRP) measurements. When muting one or several antenna ports or PAs, the RSRP measurements can be affected. For instance, a UE knowing that a radio base station has two antenna ports, dedicated for the cell served by the radio base station, may use both antenna ports for RSRP measurements and combine two measurements, one good measurement on an active antenna port and one bad, noise only, measurement on a muted antenna port. If the UEs perform maximum ratio combining (MRC) of the two estimates then this is handled properly by MRC combining weights. For equal gain combining (EGC) the effect will be more noise on the RSRP measurement(s). Since it is not known how the UE performs this combining some UEs may end up with noisier RSRP measurements when an antenna port is muted. This may be accounted for in the Radio Resource Management (RRM) algorithms used in the base station to control e.g. handover between cells. However, by increasing/boosting the downlink transmission power on the still active antenna port when the other one is muted the radio base station may compensate for affected Reference Signal Received Power (RSRP) measurements.

Note that antenna muting in LTE is not limited to the transmission of the downlink common channels PBCH, PDCCH and/or the downlink cell specific reference signals (CRS). The primary synchronization signals (PSS); and the secondary signaling signals (SSS) mentioned before may also be muted, muted or redirected in a similar way under certain assumptions, as mentioned earlier and as will be discussed below.

In an LTE network the antenna ports used for transmission of PSS and SSS are not specified. Hence it is most possible to transmit the PSS/SSS from only one antenna port. This is considered beneficial when the load in the cell is determined to be low since it enables the muting/inactivation of antenna ports. However, at full load this configuration will lead to an un-even power utilization of the power amplifiers.

Following is an example to the above. Assume that a radio base station is configured with four PAs capable of transmitting 10 W of downlink transmission power each. In total, the radio base station is capable of transmitting 4×10=40 W of downlink transmission power, but that requires all PAs to be fully utilized. Assuming that 10% of total downlink transmission power is spent on transmission of downlink common channels e.g. PBCH, PDCCH, reference signals and synchronization signals then there is a need of 4 W of downlink transmission power for this purpose. If all of that power would be transmitted from a single PA there would only be 10−4=6 W left for data transmission from that PA. Since the data channel uses all antenna ports with equal downlink transmission power then a power limit will occur on the PA that transmits overhead signals already when the data channel power reaches 4×6=24 W. In total only 24+6=30 W of downlink transmission power could then be transmitted even though the total power budget is 4×10=40 W. In this example it is assume that the time to re-allocate the power allocated to overhead channels between the PAs is significant while the traffic can vary almost instantaneously from zero to full traffic. Thus if one PA is out of power i.e. muted, then one can not increase the power of the data transmission anymore until the power of the overhead transmission is re-distributed

Therefore, most LTE networks are configured to transmit PSS and SSS, which can be viewed as overhead signals, with an equal power distribution over all available antennas. In the numerical example above, 1 W would be used on each of the 4 available PAs. Then each PA would have 9 W available for data transmission and at full load all available power would be utilized.

By introducing downlink transmission power muting and power boosting in accordance with the exemplary embodiments of the present invention, it is possible to dynamically configure how the PSS and SSS are transmitted. Thus, when the measured load is determined to be low, all downlink transmission power required for PSS/SSS transmission is compensated for i.e. put; redirect; or selected to be, on one PA and the remaining PAs may then be muted. When the measured load is determined to be high i.e. equal to or exceeds a defined value, the PSS/SSS transmission power is equally distributed over all available antennas. This power allocation re-configuration may be done at a fast time scale e.g. in an order of 10-100 ms, preferably with a power ramping procedure.

According to a further exemplary embodiment of the present invention the power control circuit is adapted to adjust the downlink transmission power on one or several antenna port(s). For example, the power control circuit is adapted to decrease the downlink transmission power back to the level used before being increased on the antenna port which was subject for an increase, and to increase, ramp-up or adjust, the antenna which was subject for the muting.

The adjustment(s) may further be based on that the measured load equals to or exceeds the defined load value i.e. based on the comparison result(s).

According to exemplary embodiments of the present invention downlink transmission power ramping of a muted antenna port and/or a delay of usage of PDCCH is introduced. This introduction is made in order to overcome or at least decrease inaccurate UE channel estimates arising when a muted antenna port is re-activated i.e. adjusted back to the downlink transmission power level used before being decreased. The PDCCH usage need in most cases can be delayed a few ms.

As previously described, the load is measured and compared with a defined value. The value can be based on one or more of the following: load measurements performed on the cell; earlier load measurements performed on the cell; and initial configuration values of the radio base station. The apparatus may further calculate (or define) the defined load value(s) by taking into consideration a report relating to a condition or conditions of neighboring cells, in the calculation/definition. The condition(s) of neighboring cells comprise(s) at least an interference indicator and/or a sensitivity indicator.

For example, when a cell has no or only little load, and consequently is generating no or little interference to neighboring cells it may report this to the neighboring cells. When receiving information e.g. a low-interference indicator, from a second neighboring cell, the received information is used to improve estimate(s) of a current SINR margin on downlink common channels. If the second neighboring cell is a dominant interfering cell then it may be determined when receiving information e.g. a low interference indicator, that the inter-cell interference is now significantly reduced. Traditional planning tools may be used in order to determine which neighboring cells that needs to be operating in low-interfering mode in order for the radio base station or the (energy control) apparatus to mute one or more antennas.

According to an exemplary embodiment of the present invention the apparatus entering an antenna muting mode in a cell may store and distribute this information to other power control apparatuses handling neighboring cells that it is currently more sensitive to inter-cell interference. When receiving information e.g. a high sensitivity indicator, on a neighbor cell the energy control apparatus may limit its downlink interference by not transmitting with full power on all physical resources for a long duration of time.

Thus, the following information may be exchanged between power control apparatuses:
Interference indicator: high or low
Sensitivity indicator: high or low

The above mentioned indicators may be used alone or in combination. The information may be exchanged directly between the power control apparatuses or the radio base stations (e.g. on the X2 interface) or via other intermediate nodes in a network e.g. an Operation and Support System (OSS) node.

It should be mentioned that the apparatus in accordance with exemplary embodiments of the present invention may be implemented as an antenna DTX controller that estimates the load in a cell it serves and/or the SINR margin on downlink control channels as previously described. Based on the estimates which, according to the embodiments of the present invention, are compared with a defined value or a threshold value, the antenna DTX controller may determine when an antenna port or ports may be DTX:ed i.e. muted in order to reduce energy consumption. The antenna DTX controller is not restricted to be part of a radio base station. For example, the antenna DTX controller can be implemented in a central node such as a radio network controller (RNC) or in an operation and support system (OSS) or in any suitable network node.

An alternative embodiment for antenna muting than just setting the transmission power of some antenna branches or antenna ports or PAs to zero is also possible. As an example, a release 8 (Rel-8) UE can be configured to only determine the number of antennas once for each cell i.e. serving cell and/or neighboring cells. Thus to enable such a Rel-8 UE to re-evaluate this decision one need to “trick” the UE into believing that it has found a new cell. On the physical layer a cell is identified with a physical cell identity (PCI), that is a short locally unique index. The PCI determines the sequences used for the primary and secondary synchronization signals (PSS/SSS) as well as the cell specific reference signals (CS-RS). If a cell is allowed to have more than one PCI in e.g. LTE Rel-10 then one PCI could be used for each antenna configuration, e.g. PCI₁, PCI₂, and PCI₄ is used when the number of active base station transmission antennas is 1, 2, and 4 respectively. Seen from a Rel-10 UE all these PCIs correspond to the same cell but seen from a Rel-8 UE they would correspond to different cells.

For instance, consider the scenario where a micro cell is transmitting PBCH, SSS, PSS, and CS-RS from only one physical antenna using the physical cell identity PCI₁. This makes it possible to Rel-8 UEs that are currently served by another cell e.g. a macro cell to detect the micro cell and report the cell with PCI₁ as a handover candidate to the serving cell. If a handover decision is taken the micro cell may first change physical cell identity to e.g. PCI₄. As a consequence the transmission sequences for SSS, PSS, and CS-RS also changes, and so does the scrambling code and CRS on the PBCH as well. The UE is then order by the serving cell to perform a handover to the new, seen from the UE perspective, cell with PCI₄. The UE will determine the number of antenna ports of the “new” cell to be equal to 4 and attach to the target cell. Thus the change of PCI for the same “cell” may occur if there are no Rel-8 UEs previously served by that target cell; otherwise those Rel-8 UEs would get “confused” when the serving cell suddenly disappears. For achieving this scenario Rel-10 UEs need to know that a set of PCIs is used by the same cell. Also neighboring cells need to know that more than one PCI is mapped to a same global cell identity (GID or cell identity PLMN level (CIPL)). Automatic neighbor relation algorithms also need to be updated accordingly. Furthermore, in case there are active Rel-8 UEs in the micro cell, they might be negatively affected by the PCI change, which might be acceptable if it happens only rarely. To avoid confusing the Rel-8 UEs it is possible to perform the handover to the macro cell before the PCI change occurs.

As known and as described above, LTE has several releases. Depending on which release is used, the number of antenna ports can be different. However, the exemplary embodiments of the present invention are not restricted to any particular number of antenna ports. For example, the number of antenna ports can be equal to the number of physical antenna elements used for data transmission in LTE system, which can be used if UE-specific reference signals are used for PDSCH demodulation. For instance, in LTE Rel-10 the specifications will support 8 transmit antenna schemes in the downlink. Applying the teaching of the exemplary embodiments of the present invention in an LTE system supporting 8 transmit antenna schemes can be performed by e.g. choose to transmit the PBCH and consequently the L1/L2 control signaling using one or two antenna ports. This would reduce the number of PAs that need to be active when the cell has no active users or UEs to one or two. Also it would reduce the number of cell specific reference signals designed for other system with fewer transmission schemes that might not be optimum for larger transmission schemes with more antenna ports. As an example, if a radio base station is equipped with a larger number of transmit antennas, some form of transparent transmit diversity can be used if all the physical antennas are to be exploited e.g., small delay, for transmission of downlink common channels when the cell load is high.

To enable antenna muting as depicted in FIG. 4A in a LTE radio base station with a large number of antenna schemes e.g. 8 antenna transmission schemes, one could make sure that 8 transmission schemes do not rely on the 4 cell-specific RS for data demodulation but rather use UE-specific RS, at least for more that 2 layers. A scheduler in the radio base station could e.g. control the actual number of antenna ports and, as a consequence, the number of power amplifiers and physical antennas as part of the scheduling decisions.

It should be mentioned that the exemplary embodiments of the present invention are not restricted to LTE only. For instance, the embodiments can be applied in WCDMA systems where common channels in in a similar way as in LTE. However in WCDMA a space time block code (STBC) is used while the SFBC is used in LTE as described earlier. Both the STBC in WCDMA and the SFBC in LTE are based on the same code denoted the Alamouti linear dispersive code. Hence the exemplary embodiments of the present invention are applicable also for WCDMA. In such a system the radio base station is called a NodeB which, when applying the teaching of the embodiments of the present invention, comprises the previously presented and illustrated energy control apparatus in conjunction with e.g. FIG. 2 and/or FIG. 3.

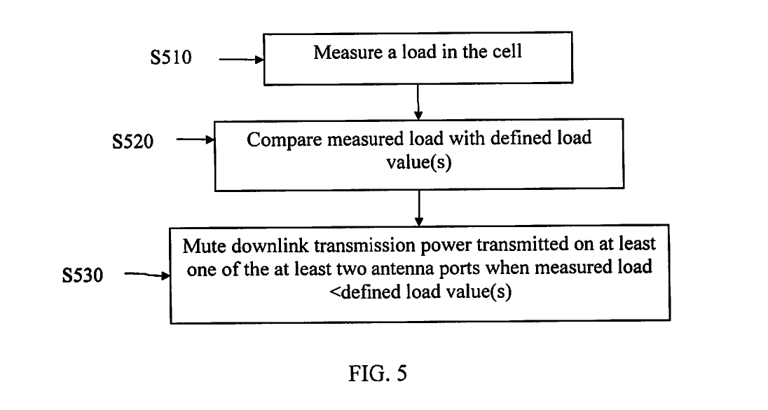

Referring now to FIG. 5 there is depicted a flow chart of main steps of a method for controlling energy consumption according to previously described exemplary embodiments of the present invention. The method is for use in a multi-antenna multi-port radio base station of a MIMO wireless communications network. The radio base station is serving a cell and comprising at least two antenna ports dedicated for that cell. The method comprises:

(S510) measuring a load in the cell and comparing;
(S520) comparing the measured load with a defined load value; and based on the comparison
(S530) muting a downlink transmission power transmitted on at least one of the at least two antenna ports when the measured load is below the defined load value.

A previously described, the muting or the inactivation can be performed on power amplifier(s) that is/are related to the antenna port(s) when the measured load is below the defined load value. Furthermore, the measuring of the load can be based on measuring one or several of the following: cell traffic load; data rate; number of served user equipments in the cell; SINR margin on downlink common channels; time period statistics; type of UEs in the cell and packet delay estimations.

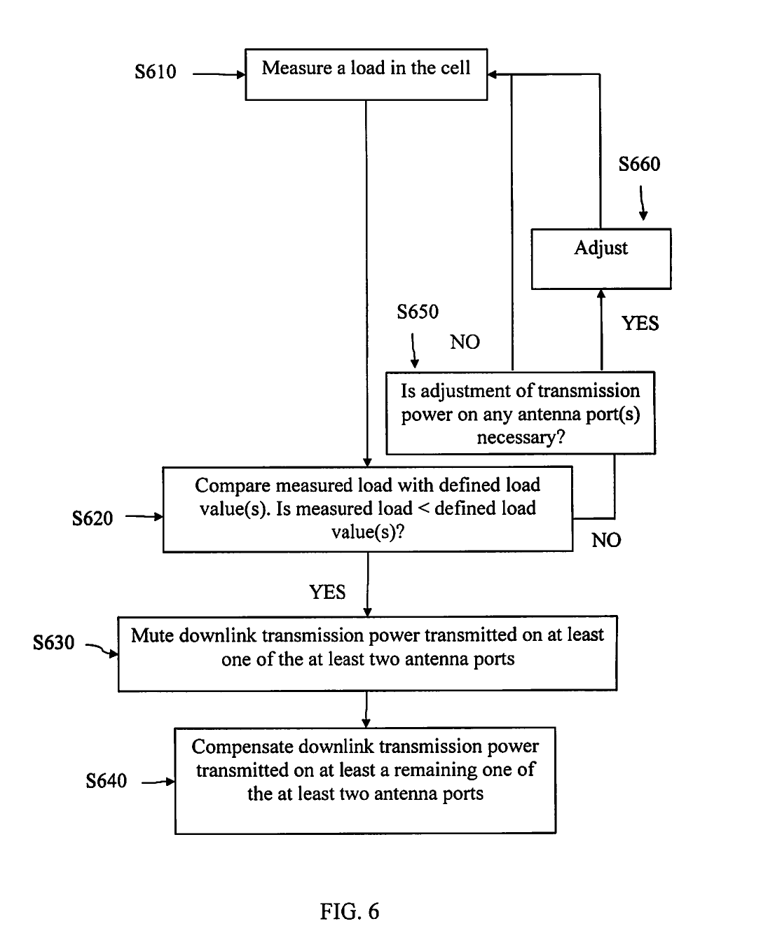

Referring to FIG. 6 there is illustrated a flowchart of a method for controlling energy consumption according to some exemplary embodiment of the present invention. As shown, the following is performed:

(S610) measuring a load in the cell and comparing;
(S620) comparing the measured load with a defined load value; and in case the load is less that the defined value;
(S630) muting a downlink transmission power transmitted on at least one of the at least two antenna ports when the measured load is below the defined load value; and
(S640) after the muting has been performed, compensating for a loss of transmission of one or more of the following: downlink common channels; pilot signals; downlink-cell specific reference signals; primary synchronization signals; and secondary signaling signals. The loss is a result caused by the decrease of downlink transmission power on the one of the at least two antenna ports;

Compensation for a loss of downlink transmission power can also be done by increasing the downlink transmission power on a remaining one of the at least two antenna ports. The method may also in combination with downlink transmission power increasing, or separately, compensate by dynamically adjusting the code rate.

Referring back to FIG. 6, in case the measured load is larger than or equal to the defined value(s), the method comprises, as shown:

(S650) determining whether adjustment of the downlink transmission power on one or more antennas is necessary and if the answer is yes, adjustment is performed in (S660) before going back to step (S610). The adjustment is performed as previously described. Note that load measurements are (continuously) be performed and thus when the load in the cell is determined to be high i.e. based on comparison results, the settings of the apparatus need to be dynamically adjusted. Note also that different load values may be defined for the decreasing and the adjustment i.e. one defined value for when to start decreasing and one separate different defined value for when to start the adjustment. Thus, the adjusting in (S660) may comprise decreasing the downlink transmission power back to the downlink transmission power level used before being increased i.e. on the remaining one of the at least two antenna ports and/or adjustment by increasing the downlink transmission power back to the downlink transmission power level used before being decreased i.e. on the at least one of the at least two antenna ports.

Again, the defined load value used for comparison with the measured load can be based on one or more of the following: load measurements performed on the cell; earlier load measurements performed on the cell; and initial configuration values of the radio base station. Additionally, the defined load value may be calculated by further taking into consideration a report relating to one or more conditions of neighboring cells. Several reports may also be used and the reports may be exchanged continuously between radio base stations or energy control apparatuses.

Note that although the illustrating examples relates to LTE and WCDMA networks the exemplary embodiments of the present invention are not to be considered limited to only LTE network or to only WCDMA network but may be successfully implemented in for example WiMAX, WLAN, cdma200 networks etc.

The present invention and its exemplary embodiments can be realized in many ways. For example one embodiment of the present invention includes a computer-usable or computer-readable medium comprising a computer program code configured to cause a processor or a computer node to execute instructions stored thereon and/or to execute any of the above mentioned methods. The executable instructions perform the method steps of the exemplary embodiments of the present invention as previously described and as presented in the appended method claims.

As previously described, the apparatus for controlling energy according to the embodiments of the present invention may be part of: a radio base station; a RNC node; a OSS node; or any other suitable network node. The energy control apparatus may also include circuits that are distributed between several nodes of a wireless communications network.

While the invention has been described in terms of several preferred embodiments, it is contemplated that alternatives, modifications, permutations and equivalents thereof will become apparent upon reading of the specifications and upon study of the drawings. It is therefore intended that the following appended claims include such alternatives, modifications, permutations and equivalents as fall within the scope of the present invention.

1-21. (canceled)

22. An apparatus for controlling energy, for use in a multi-antenna multi-port radio base station of a multiple-input multiple-output (MIMO) wireless communications network, which radio base station is configured to serve a cell and comprises at least two antenna ports dedicated for that cell, the apparatus comprising:
a measurement circuit adapted to measure a load in the cell;
a comparator circuit adapted to compare the measured load with a defined load value; and
a power control circuit adapted to mute a downlink transmission power transmitted on at least one of the at least two antenna ports in response to determining that the measured load is below the defined load value.

23. The apparatus of claim 22, wherein the measurement circuit is adapted to measure the load in the cell by measuring one or more of the following: cell traffic load; data rate; number of served user equipments in the cell; number of scheduled resource elements; Signal-to-Interference-plus-Noise Ratio (SINR) margin on downlink common channels; time period statistics; type of user equipment(s) in the cell; and packet delay estimations.

24. The apparatus of claim 22, wherein the power control circuit is further adapted to compensate for a loss of transmission of one or more of the following: downlink common channels; pilot signals; downlink-cell specific reference signals; primary synchronization signals; and secondary signaling signals, caused by the decrease of downlink transmission power on the one of the at least two antenna ports.

25. The apparatus of claim 24, wherein the power control circuit is adapted to compensate for a loss of downlink transmission power by increasing the downlink transmission power on a remaining one of the at least two antenna ports.

26. The apparatus of claim 25, wherein the power control circuit is adapted to adjust the downlink transmission power on the remaining one of the at least two antenna ports by decreasing the downlink transmission power back to the downlink transmission power level used before being increased, in response to determining that the measured load is equal to or exceeds the defined load value.

27. The apparatus of claim 22, wherein the power control circuit is adapted to adjust the downlink transmission power on the one of the at least two antenna ports by increasing the downlink transmission power back to the downlink transmission power level used before being decreased, in response to determining that the measured load is equal to or exceeds the defined load value.

28. The apparatus of claim 22, wherein the defined load value is defined based on one or more of the following: load measurements performed on the cell; earlier load measurements performed on the cell; and initial configuration values of the radio base station.

29. The apparatus of claim 28, wherein the defined load value is calculated by further taking into consideration a report relating to a condition of neighboring cells.

30. The apparatus of claim 29, wherein the report relating to the condition of neighboring cells comprises an interference indicator, or a sensitivity indicator, or both.

31. A radio base station in a wireless communications network, the radio base station comprising the apparatus of claim 22.

32. A radio network controller in a wireless communications network, the radio network controller comprising the apparatus of claim 22.

33. A method for controlling energy consumption and for use in a multi-antenna multi-port radio base station of a multi-input multi-output (MIMO) wireless communications network, which radio base station serves a cell and comprises at least two antenna ports dedicated for that cell, the method comprising:
measuring a load in the cell;
comparing the measured load with a defined load value; and
muting a downlink transmission power transmitted on at least one of the at least two antenna ports in response to determining that the measured load is below the defined load value.

34. The method of claim 33, wherein measuring the load in the cell comprises measuring one or more of the following: cell traffic load; data rate; number of served user equipments in the cell; and Signal to Interference-plus-Noise Ratio (SINR) margin on downlink common channels; time period statistics; type of user equipment(s) in the cell; and packet delay estimations.

35. The method of claim 33, further comprising:
compensating for a loss of transmission of one or more of the following: downlink common channels; pilot signals; downlink-cell specific reference signals; primary synchronization signals; and secondary signaling signals, caused by the decrease of downlink transmission power on the one of the at least two antenna ports.

36. The method of claim 35, wherein compensating for the loss of downlink transmission power comprises increasing the downlink transmission power on a remaining one of the at least two antenna ports.

37. The method of claim 36, further comprising:
adjusting the downlink transmission power on the remaining one of the at least two antenna ports by decreasing the downlink transmission power back to the downlink transmission power level used before being increased, in response to determining that the measured load is equal to or exceeds the defined load value.

38. The method of claim 33, further comprising:
adjusting the downlink transmission power on the one of the at least two antenna ports by increasing the downlink transmission power back to the downlink transmission power level used before being decreased, in response to determining that the measured load is equal to or exceeds the defined load value.

39. The method of claim 33, further comprising defining the defined load value based on one or more of the following: load measurements performed on the cell; earlier load measurements performed on the cell; and initial configuration values of the radio base station.

40. The method of claim 39, further comprising calculating the defined load value by further taking into consideration a report relating to a condition of neighboring cells.

41. The method of claim 40, further comprising receiving load measurements relating to the condition of neighboring cells or performing load measurements relating to the condition of neighboring cells, or both, the condition comprising an interference indicator, or a sensitivity indicator, or both.

42. A computer-readable medium comprising a computer program code configured to, when run on a processor or a computer node use in a multi-antenna multi-port radio base station of a multi-input multi-output (MIMO) wireless communications network, which radio base station serves a cell and comprises at least two antenna ports dedicated for that cell, cause the processor or the computer node to:
measure a load in the cell;
compare the measured load with a defined load value; and
mute a downlink transmission power transmitted on at least one of the at least two antenna ports in response to determining that the measured load is below the defined load value.
